(19) United States
(12) Patent Application Publication
(10) Pub. No.: US 2009/0100223 A1
(43) Pub. Date: Apr. 16, 2009

(54) Storage control apparatus, data archive method for storage control apparatus, and storage system

(75) Inventors: Tomonori Murayama, Yokohama (JP); Yoichi Mizuno, Yokohama (JP)

Correspondence Address: Stanley P. Fisher;Reed Smith LLP, Suite 1400, 3110 Fairview Park Drive, Falls Church, VA, 22042-4503, US

(73) Assignees: Hitachi, Ltd.; Hitachi Computer Peripherals Co., Ltd.

(21) Appl. No.: 12/068,424

(22) Filed: Feb. 6, 2008

(30) Foreign Application Priority Data
Oct. 11, 2007 (JP) 2007-265942

(51) Int. Cl. G06F 12/00

(52) U.S. Cl. 711/114; 711/E12.001

(57) ABSTRACT

The storage control apparatus of the present invention efficiently shifts data which are stored in a virtual volume from a random access-type storage device to a sequential access-type storage device. The virtual volume is constituted by a plurality of pages. Each page is associated with either a segment of a disk device or a segment of a tape device. Data which have not been accessed by the host are collected in page units in a spare disk device for data migration. The data are copied from the migration source disk device to the migration destination tape device. The segment assignment destination of the page of the virtual volume is changed from a segment in the disk device to a segment in the tape device.

### CROSS-REFERENCE TO RELATED APPLICATIONS

This application relates to and claims priority from Japanese Patent Application No. 2007-265942 filed on Oct. 11, 2007 the entire disclosure of which is incorporated herein by reference.

### BACKGROUND

The present invention relates to a storage control apparatus, a data archive method for a storage control apparatus, and a storage system.

In order to handle large quantities of data of multiple types at government agencies, enterprises, and educational establishments, for example, data are managed using a relatively large-scale storage system. This storage system comprises at least one storage control apparatus. The storage control apparatus comprises a multiplicity of storage devices, for example, and is able to provide a RAID (Redundant Array of Inexpensive Disks)-based storage area. At least one or more logical devices (also known as logical volumes) are formed in a physical storage area that is provided by a storage device group. A host computer (‘host’ hereinbelow) carries out the writing of data and the reading of data by issuing write commands and read commands to the logical devices.

A virtual disk library system which is one of storage control apparatuses comprises a hard disk device and a magnetic tape device in an enclosure and, if necessary, is adapted to be able to copy data between the disk and magnetic tape (Japanese Application Laid Open No. 2007-102455).

The present applicant has disclosed a technology for copying data between a disk and magnetic tape in logical volume units in the specification of Patent Application No. 2006-135773. However, the specification of Patent Application No. 2006-135773 has not yet been published and does not apply to conventional technology.

Data for which long-term storage is stipulated in accordance with legal regulations is increasing on a daily basis. In order to protect large quantities of data for long periods, a storage device for which costs are as stable as possible is preferably used. Therefore, the storage of data that does not need to be saved in a hard disk device in a magnetic tape device whose per-bit costs are more stable than those of a hard disk device may be considered. As a result, the costs of archiving the data for long periods are reduced.

Here, shifting data from the hard disk device to the magnetic tape device in logical volume units may also be considered. All the data in the logical volume are archive targets and, in cases where access has not been made by the host, the data can be shifted from the hard disk device to the magnetic tape device in logical volume units. However in cases where even one data item which is not an archive target exists in a logical volume, data cannot be shifted from the hard disk device to the magnetic tape device. Therefore, there are fewer opportunities to shift data to an inexpensive magnetic tape device, and the results of reducing data archiving costs are low.

Furthermore, in cases where data are copied between a hard disk device and a magnetic tape device, the copy speed must be constant. Because a magnetic tape device is a sequential access storage device, the quality of the data copy can be maintained by keeping the copy speed constant. Conversely, in cases where the copy speed is unstable, because there is work involved in rewinding the magnetic tape during data copy, the possibility arises that accurate storage of the data to the magnetic tape will not be possible.

### SUMMARY

The present invention was conceived in view of the above problem and an object of the present invention is to provide a storage control apparatus that allows data to be shifted between a random access storage device and a sequential access storage device in a predetermined size that is smaller than the size of the virtual volume, a data archive method for the storage control apparatus, and a storage system. A further object of the present invention is to provide a storage control apparatus that is constituted to prevent a drop in the quality of the data copy by stabilizing the copy speed between a random-access storage device and a sequential access storage device, a data archive method for the storage control apparatus, and a storage system. Further objects of the present invention will become evident from the subsequent embodiments.

In order to solve the above problem, a storage control apparatus that is utilized by a host computer according to the present invention comprises a virtual volume which is constituted by a plurality of virtual storage areas of a predetermined size which are each associated with a real storage area; a data migration control section that detects a migration target virtual storage area among the respective virtual storage areas and either shifts data stored in the detected migration target virtual storage area from the real storage area of a random access-type storage device to the real storage area of a sequential access-type storage device or shifts the data stored in the detected migration target virtual storage area from the real storage area of the sequential access-type storage device to the real storage area of the random access-type storage device; and a virtual volume control section which generates the virtual volume and supplies the virtual volume to the host computer, and which associates the virtual storage area with either the real storage area of the random access-type storage device or the real storage area of the sequential access-type storage device on the basis of the result of the data migration by the data migration control section.

The data migration control section is able to use a spare storage area in which data that is likely to be accessed by the host computer are not stored, to shift data between the random access-type storage device and the sequential access-type storage device.

The data migration control section is configured such that (1) in cases where an archive target virtual storage area among the respective virtual storage areas which matches a preset archive policy is detected, the data migration control section is able to shift data which are stored in the real storage area of the random access-type storage device which is associated with the archive target virtual storage area to the real storage area of the sequential access-type storage device, and (2) in cases where a recovery instruction is issued for the virtual storage area among the respective virtual storage areas which is associated with the real storage area of the sequential access-type storage device, the data migration control section is able to shift data which are stored in the real storage area of the sequential access-type storage device to the real storage area of the random access-type storage device.

The archive policy can be a case where the elapsed time since the last time access is performed by the host computer exceeds a predetermined time that is preset, or a case where the frequency of access by the host computer is less than a predetermined value that is preset, or a case where an archive instruction is issued by the host computer.

The virtual volume control section is able to report an error to the host computer in cases where the host computer accesses the virtual storage area associated with the real storage area of the sequential access-type storage device among the respective virtual storage areas.

According to an embodiment of the present invention, the storage control apparatus further comprises a data management section that manages the correspondence relationship between the content data utilized by the host computer and the respective virtual storage areas, and manages whether the content data are stored in either the real storage area of the random access-type storage device or the real storage area of the sequential access-type storage device, wherein, as a result of the data management section issuing an archive instruction or recovery instruction to the data migration control section, the data migration control section shifts the data stored in the migration target virtual storage area from the real storage area of the random access-type storage device to the real storage area of the sequential access-type storage device, or shifts the data stored in the migration target virtual storage area from the real storage area of the sequential access-type storage device to the real storage area of the random access-type storage device.

The random access-type storage device may be either a hard disk device or a flash memory device, and the sequential access-type storage device may be a magnetic tape device.

A data archiving method for a storage control apparatus according to another aspect of the present invention comprises the steps of generating a virtual volume from a plurality of virtual storage areas of a predetermined size which can be associated with either a real storage area of a random access-type storage device or a real storage area of a sequential access-type storage device; detecting an archive target virtual storage area among the respective virtual storage areas; shifting data stored in the real storage area of the random access-type storage device which corresponds with the detected archive target virtual storage area to the real storage area of the sequential access-type storage device by using a spare storage area; associating the archive target virtual storage area with the real storage area of the migration destination sequential access-type storage device; and responding to access to the archive target virtual storage area with an error.

In addition, the data archiving method for a storage control apparatus further comprises a step of shifting data that have been shifted to the real storage area of the migration destination sequential access-type storage device, to the real storage area of the random access-type storage device in cases where the recovery instruction has been issued.

A storage system according to yet another aspect of the present invention is a storage system having a host computer and a library system that is utilized by the host computer, wherein (1) the library system comprises a first storage section that has a plurality of random access-type storage devices, a second storage section that has a plurality of sequential access-type storage devices, and a controller for controlling the first storage section and the second storage section; (2) the controller comprises: (2-1) a virtual volume which is constituted by a plurality of virtual storage areas of a predetermined size, each of the virtual storage areas being associated with a real storage area; (2-2) a data migration control section that detects a migration target virtual storage area among the respective virtual storage areas, and (2-2-1) shifts data stored in the detected migration target virtual storage area from the real storage area of the random access-type storage device to the real storage area of the sequential access-type storage device or (2-2-2) shifts the data stored in the detected migration target virtual storage area from the real storage area of the sequential access-type storage device to the real storage area of the random access-type storage device; and (2-3) a virtual volume control section which generates the virtual volume and supplies the virtual volume to the host computer, and which associates the virtual storage area with either the real storage area of the random access-type storage device or the real storage area of the sequential access-type storage device on the basis of the result of the data migration by the data migration control section; (3) the host computer comprises a data management section that manages the correspondence relationship between the content data and the respective virtual storage areas, and manages whether the content data are stored in either the real storage area of the random access-type storage device or the real storage area of the sequential access-type storage device; and (4) the data migration control section shifts data between the random access-type storage device and the sequential access-type storage device on the basis of an archive instruction or recovery instruction issued by the data management section.

All or some of the means, functions, and steps of the present invention can be sometimes constituted as a computer program that is executed by a computer system. In cases where all or some of the constitution of the present invention is constituted by a computer program, the computer program can be distributed by being secured on various storage media or can be transmitted via a communication network, for example.

### BRIEF DESCRIPTION OF THE DRAWINGS

FIG. 1 is a conceptual view showing an embodiment of the present invention;

FIG. 2 is a hardware constitutional view of the system according to the embodiment of the present invention;

FIG. 3 is an explanatory diagram that schematically shows the stored content of a control memory;

FIG. 4 is an explanatory diagram of the relationship between virtual volumes, and a disk pool and TG pool;

FIG. 5 is an explanatory diagram of a virtual volume management table;

FIG. 6 is an explanatory diagram of a page management table;

FIG. 7 is an explanatory diagram of a disk pool management table;

FIG. 8 is an explanatory diagram of a TG pool management table;

FIG. 9 is an explanatory diagram of a content management table;

FIG. 10 is a flowchart showing processing of inactivate;

FIG. 11 is an explanatory diagram that shows the state before starting a data archive to tape;

FIG. 12 is an explanatory diagram showing a state in which data of an archive target are collected in a data migration disk device;

FIG. 13 is an explanatory diagram showing a state where data are shifted from a disk device to a tape device;

FIG. 14 is a flowchart showing processing of activate;

FIG. 15 is a flowchart showing processing of inactivate according to a second embodiment; and

FIG. 16 is an explanatory diagram showing the overall constitution of a system according to a third embodiment.

### DESCRIPTION OF THE PREFERRED EMBODIMENTS

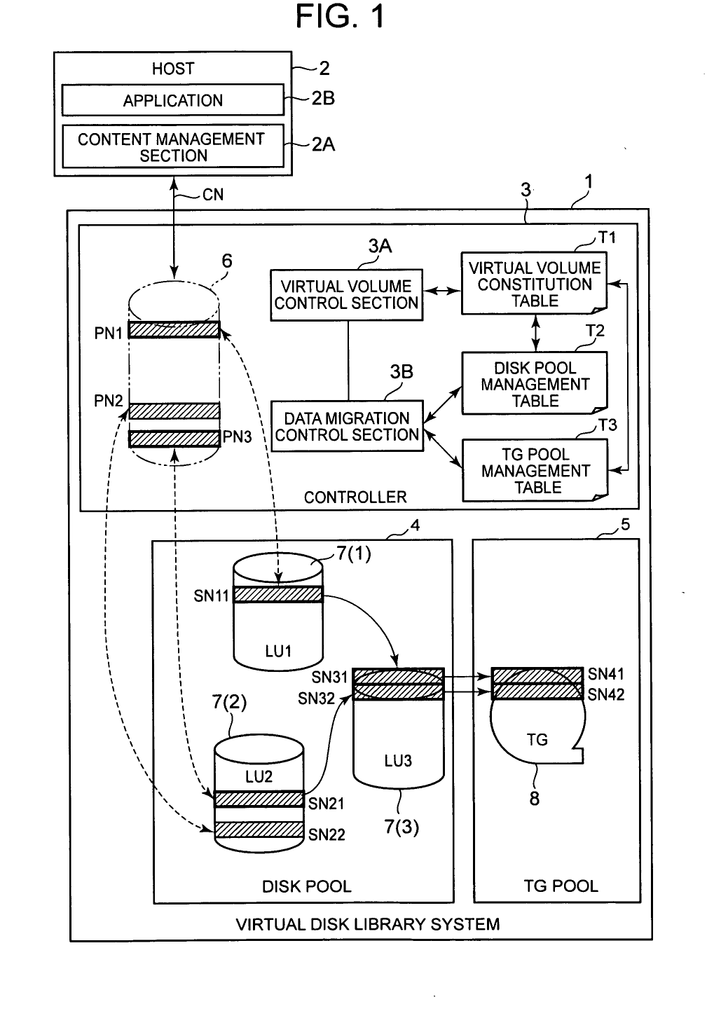

FIG. 1 is a constitutional explanatory diagram that shows the overall concept of an embodiment of the present invention. According to this embodiment, as will be described subsequently, a virtual volume 6 is managed using a predetermined size that is smaller than the volume size and data can be shifted between storage devices 7 and 8 of different types using a predetermined size.

The storage system shown in FIG. 1 comprises, for example, a virtual disk library system 1 and a host 2. The host 2 will be described first. The host 2 is constituted as a computer device such as a mainframe computer, a server computer, a workstation, or a personal computer, for example. The host 2 comprises a content management section 2A and an application program 2B. The content management section 2A manages the whereabouts and states of the content data which are utilized by the application program 2B.

The host 2 and virtual disk library system 1 are connected via a communication network CN such as an FC_SAN (Fibre Channel_Storage Area Network), an IP_SAN (Internet Protocol_SAN), or a LAN (Local Area Network), for example.

In cases where the host 2 is a mainframe computer, a communication protocol such as FICON (Fibre Connection: registered trademark), ESCON (Enterprise System Connection: registered trademark), ACONARC (Advanced Connection Architecture: registered trademark), FIBARC (Fibre Connection Architecture: registered trademark), for example, is used. In cases where the host 2 is a server computer or a personal computer or the like, for example, a communication protocol such as TCP/IP (Transmission Control Protocol/Internet Protocol), FCP (Fibre Channel Protocol), iSCSI (internet Small Computer System Interface), for example, is used.

The virtual disk library system 1 will now be described. The virtual disk library system 1 which is a ‘storage control apparatus’ comprises a controller 3, a disk pool 4, and a TG (tape group) pool 5, for example.

The controller 3 controls the virtual disk library system 1. The controller 3 generates virtual volume 6 and supplies same to the host 2 and processes data input/output requests (I/O requests) from the host 2. The controller 3 comprises, for example, a virtual volume control section 3A, a data migration control section 3B, a virtual volume constitution table T1, a disk pool management table T2, and a TG group management table T3.

The disk pool 4 manages a plurality of disk devices 7(1) to 7(3) which are sometimes collectively referred to as the ‘disk devices 7’. Here, ‘disk devices 7’ signifies logical device disks which is generated from the storage area of one or a plurality of hard disk drives. Hence, the characters ‘LU (Logical Unit)’ have been provided for the disk devices 7 in FIG. 1. The disk devices 7 are also called logical volumes.

The disk devices 7 are an example of ‘random access-type storage devices’. Hard disks that can be used include, for example, FC (Fibre Channel) disks, SCSI (Small Computer System Interface) disks, SATA disks, ATA (AT Attachment) disks, SAS (Serial Attached SCSI) disks and so forth. Further, random access-type storage devices are not limited to hard disk devices. Rather, a variety of random access-type storage devices such as flash memory devices, magneto-optical disks, optical disks, FeRAM (Ferroelectric Random Access Memory), MRAM (MagnetoresistiveRandomAccess Memory), Ovonic Unified Memory, and RRAM (Resistance RAM), for example, can be utilized.

The TG pool 5 manages a plurality of tape devices 8 (only one is illustrated). One or a plurality of tape devices 8 are utilized grouped in accordance with the size of the archive target data. That is, archive target data are stored in one set of tape sets. Although magnetic tape devices 8 are presented as examples of sequential access-type storage devices in this embodiment, the present invention is not limited to magnetic tape devices.

The virtual volume 6 is a logical volume that is constituted virtually. The virtual volume 6 is constituted by a plurality of pages (‘PN’ in FIG. 1). Each page is associated with either a segment in a disk device 7 (SN in FIG. 1) or a segment in a tape device 8. For example, page PN1 is associated with segment SN11 in disk device 7(1) and pages PN2 and PN3 are associated with segments SN21 and SN22 in disk device 7(2).

That is, the address space of the virtual volume 6 is managed in page units of a ‘predetermined size’. Each page is associated with any real storage area of a disk device 7 or tape device 8. Each page can be set at a size corresponding to one thousand logical blocks, for example. However, the page size is not limited to one thousand logical blocks.

The controller 3 associates a real storage area of the disk device 7 with a position in which data writing is required in accordance with a write request from the host 2. The write data received from the host 2 are stored in the real storage area which corresponds with the write destination address in the virtual volume 6. Therefore, the real storage area of the disk device 7 may be assigned to the virtual volume 6 only in the quantity that is actually used by the host 2. As a result, a virtual volume 6 of a larger size can be generated by means of a small real storage area.

The constitution of the controller 3 will now be described. The virtual volume control section 3A is, as mentioned earlier, a function that generates the virtual volume 6 and supplies same to the host 2. The data migration control section 3B detects the migration target data and shifts the migration target data between the disk devices 7 and tape devices 8.

The virtual volume control section 3A manages the constitution of the virtual volume 6 by using the virtual volume constitution table T1. The virtual volume constitution table T1 will be implemented as a virtual volume management table 203 and page management table 204 in subsequent embodiments.

The data migration control section 3B shifts data in two modes. In the first mode, data are shifted from a disk device 7 to a tape device 8. In the second mode, data are shifted from a tape device 8 to a disk device 7. The data migration control section 3B uses table T2 for managing disk pool 4 and table T3 for managing TG pool 5.

The first mode is a mode for releasing and re-using a real storage area of a disk device 7 by shifting data that have not been used by the host 2 from the disk device 7 to a tape device 8. The first mode will sometimes be referred to as the inactive mode in this specification. The first mode is also called the archive mode. In cases where the data of a page in the virtual volume 6 are shifted from a segment of the real storage area in the disk device 7 to a segment of the real storage area in the tape device 8 in accordance with the first mode, the state of the migration target page is set to inactive. An inactive state signifies that a state where the data storage destination exists in the tape device 8 and access by the host 2 is not received.

The second mode is a mode that allows data which are archived in a tape device 8 to be accessed by the host 2 by shifting the data to a disk device 7. In this specification, the second mode will sometimes be referred to as the active mode. The second mode is also called the restore mode.

The data migration control section 3B manages data migration between the disk devices 7 and tape devices 8 by using disk pool management table T2 and TG pool management table T3.

The operation of this embodiment will now be described. First of all, the virtual volume control section 3A generates virtual volume 6 and supplies same to host 2. Whenever the host 2 writes data to the virtual volume 6, the virtual volume control section 3A assigns a segment of a disk device 7 to the virtual volume 6.

The probability of the data which are written to the virtual volume 6 by the host 2 being accessed by the host 2 drops as time elapses and are ultimately not completely used. The data migration control section 3B detects data which have not been used by the host 2 on the basis of the time that has elapsed since the last access time or the most recent access probability, for example. The data which have not been used are the archive target. In FIG. 1, pages PN1 and PN3 which are indicated by means of a bold black frame are archive targets.

The data migration control section 3B prepares an archive spare disk device 7(3) prior to the data archive. The spare disk device 7(3) is a disk device that does not possess a single data item that has the probability of being accessed by the host 2 and corresponds to a ‘spare storage area’.

The data migration control section 3B shifts the data of the archive target pages PN1 and PN3 from the storage destination disk devices 7(1) and 7(2) to spare disk device 7(3). That is, the archive target page PN1 is associated with segment SN11 in disk device 7(1) and the data of segment SN11 are shifted to segment SN31 in disk device 7(3). The archive target page PN3 is associated with segment SN21 in disk device 7(2) and the data of the segment SN21 are shifted to segment SN32 in disk device 7(3).

Subsequently, after collecting the data of archive target pages PN1 and PN3 in the disk device 7(3) used for the archive operation, the data migration control section 3B issues an instruction for a data copy from disk device 7(3) which is the migration source device to tape device 8 which is the migration destination device. As a result, the data of the archive target page are shifted to the segments SN41 and SN42 in the tape device 8.

The virtual volume control section 3A updates the virtual volume constitution table T1 and changes the physical position of pages PN1 and PN3 in the virtual volume 6 to segments SN41 and SN42 in the tape device 8. Prior to archiving, the physical position of page PN1 is segment SN11 of the disk device 7(1) but the physical position of page PN1 after the archiving is changed to segment SN41 of the tape device 8. Likewise, prior to the archiving, the physical position of page PN3 is segment SN21 of the disk device 7(2) but the physical position of page PN3 after the archiving is changed to segment SN42 of the tape device 8.

The states of pages PN1 and PN3 which are associated with segments SN41 and SN42 in the tape device are changed from the active state (a state where data exist in the disk device) to an inactive state (a state where data do not exist in the disk device). The content data are stored on any page in the virtual volume and the state of the page is reported by the controller 3 to the content management section 2A as being either active or inactive.

In cases where the host 2 accesses a page in an inactive state, the controller 3 reports an error to the host 2. Further, as mentioned earlier, the constitution may be such that the content management section 2A grasps the state of the page in which the content data are stored and, therefore, the content management section 2A denies access to content data in an inactive state.

In cases where there is a desire to utilize data that have been shifted to the tape device 8, the content management section 2A issues an activate command to the controller 3. The activate command is a command to shift the data that have been archived in the tape device 8 to the disk device 7 and establish a state where the data can be accessed by the host 2. The activate command corresponds to a ‘restore instruction’.

When the controller 3 receives an activate command, the data migration control section 3B prepares a spare disk device 7 used for data migration and reads data from the tape device 8 in which the content data are stored. The data thus read are stored in a spare disk device 7.

The virtual volume control section 3A assigns a segment of the disk device 7 in which the content data are stored to a page of the virtual volume 6. As a result, the host 2 is able to utilize content data by accessing the page of the virtual volume 6.

What should be noted here is that the position of the page in which the content data are stored is not changed and only the physical position associated with the pages changes. That is, to cite an example, data which are stored in segment SN41 of the tape device 8 are copied to segment SN31 of the disk device 7(3). The virtual volume control section 3A associates the segment SN31 with the page PN1 of the virtual volume 6.

The segment which is originally associated with page PN1 is SN11 of disk device 7(1). As a result of the activate command being executed, the segment which is associated with page PN1 is segment SN31 of the disk device 7(3) to which data are copied from the tape device 8. The storage destination of the content data is page PN1 before and after the execution of the activate command and does not change.

An embodiment with this constitution affords the following effects. In this embodiment, the virtual volume 6 is constituted by a plurality of pages smaller than the volume size and it is possible to shift data from the disk device 7 to tape device 8 in page units. Therefore, the granularity of the data migration can be reduced to a lower speed than in a case where data are shifted to the tape device 8 in volume units. As a result, the data archiving costs can be reduced by efficiently switching data which do not need to be held in the disk device from the disk device 7 to the tape device 8.

In this embodiment, data are copied from the disk device 7 to the tape device 8 by using a spare disk device which has a small probability of being accessed by the host 2 (or absolutely no probability of being accessed). Hence, the speed of the data copy can be kept constant and the reliability of the data stored in the tape device 8 can be increased.

In this embodiment, the physical position of the page of the virtual volume 6 can be associated with either a disk device 7 or a tape device 8 and a page that is associated with a tape device 8 is set to an inactive state. Hence, the actual storage destination can be changed without changing the position of the data in the virtual volume 6.

In this embodiment, the data storage destination is changed between the disk device 7 and the tape device 8 within the virtual disk library system 1. Hence, data migration is possible without affecting host 2. This embodiment will be described in detail hereinbelow.

### First Embodiment

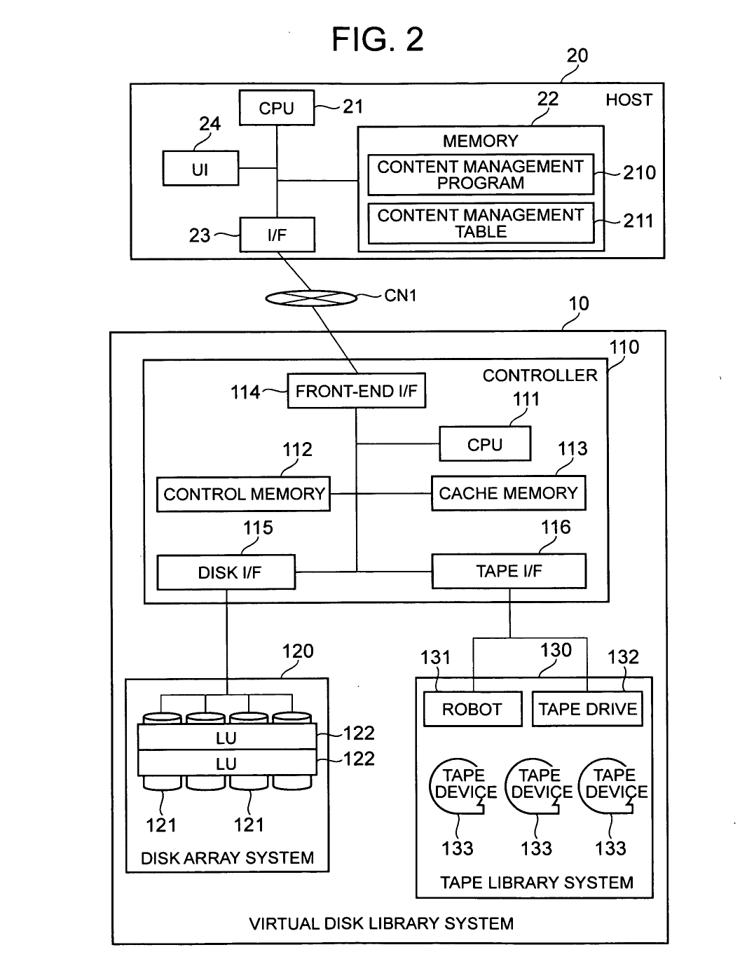

FIG. 2 is an explanatory diagram of the overall concept of the storage system of this embodiment. To first explain the correspondence relationship of FIG. 2 with FIG. 1: the virtual disk library system 10 in FIG. 2 corresponds to the virtual disk library system 1 in FIG. 1; the host 20 in FIG. 2 corresponds to the host 2 in FIG. 1; the communication network CN1 in FIG. 2 corresponds to the communication network CN in FIG. 1.

The content management program 210 and the content management table 211 in FIG. 2 correspond to the content management section 2A in FIG. 1. The controller 110 in FIG. 2 corresponds to the controller 3 in FIG. 1; the logical disk device (logical volume) 122 in FIG. 2 corresponds to the disk device 7 in FIG. 1; and the tape device 133 in FIG. 2 corresponds to the tape device 8 in FIG. 1.

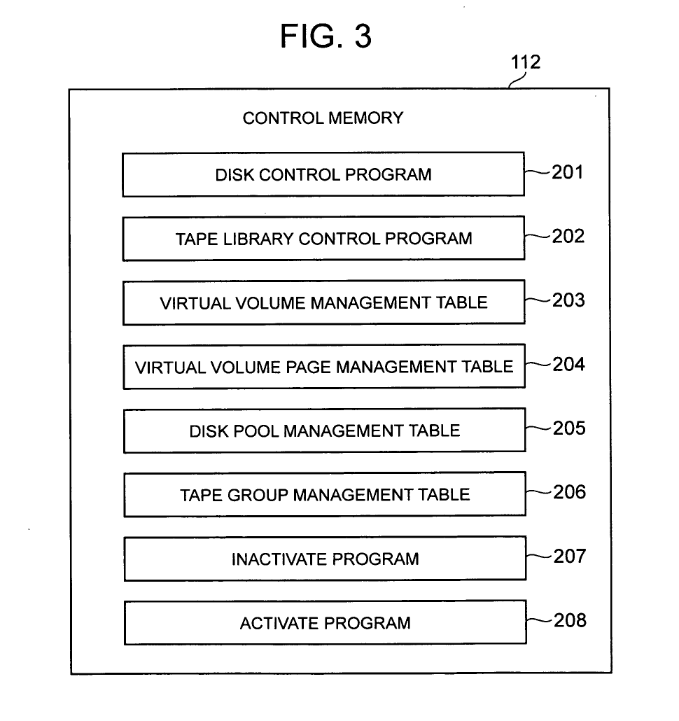

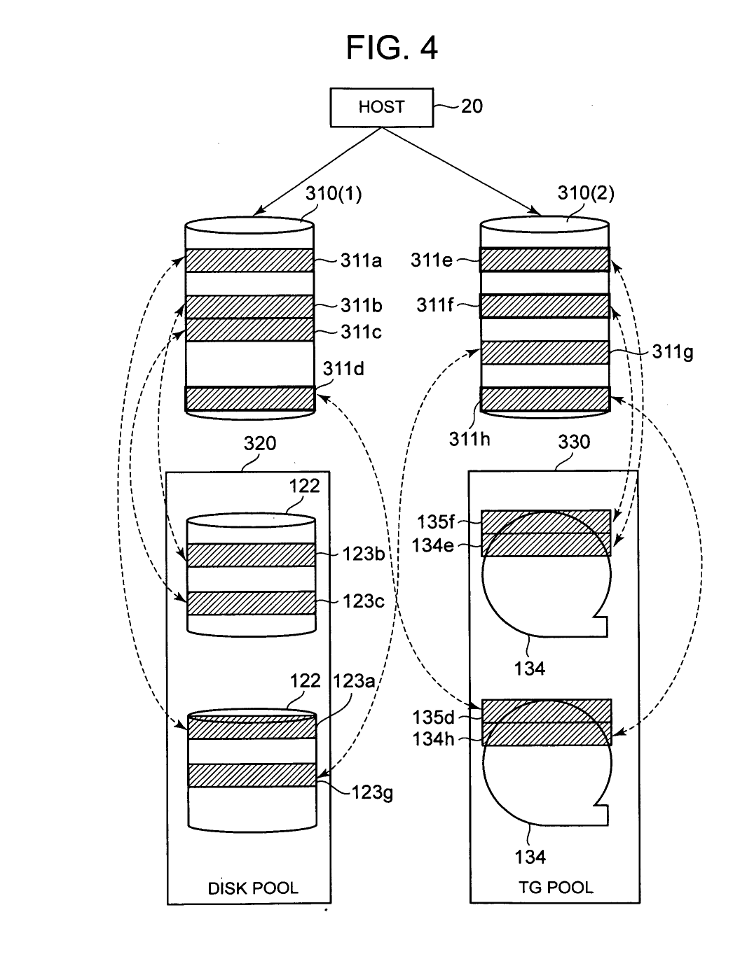

The virtual volume 310 shown in FIG. 4 corresponds to the virtual volume 6 in FIG. 1. The disk control program 201 shown in FIG. 3 corresponds to the virtual volume control section 3A in FIG. 1; the inactivate program 207 and activate program 208 in shown in FIG. 3 correspond to the data migration control section 3B in FIG. 1. The parts that overlap with the earlier description will be described in simple terms hereinbelow.

The storage system comprises a virtual disk library system 10 and a host 20 which is connected via communication network CN1 to the virtual disk library system 10. Host 20 can be constituted comprising a microprocessor (CPU) 21, a memory 22, a communication interface (I/F) 23, and a user interface (UI) 24, for example. The memory 22 stores content management program 210 and content management table 211. The memory 22 also stores various driver software and so forth but these are omitted from the description because same do not fall within the scope of the present invention.

The content management program 210 stored in the memory 22 is read by the microprocessor 21 and executed thereby. The content management program 210 is able to issue an inactivate command or an activate command. In cases where a program or function is the subject in the following description, in reality, the processing is executed by the microprocessor that executes the program or various circuits.

The virtual disk library system 10 is constituted comprising a controller 110, a disk array system 120, and a tape library system 130. The controller 110, disk array system 120, and tape library system 130 can also be provided in the same enclosure or can be provided in separate enclosures.

The controller 110 controls the operation of the virtual disk library system 10. The controller 110 comprises, for example, a microprocessor 111, a control memory 112, a cache memory 113, a front-end communication interface 114, a disk interface 115, and a tape interface 116.

The control memory 112 stores various programs 201, 202, 207, and 208 as per FIG. 3 and tables 203, 204, 205, and 206. The function to generate the virtual volume 310 and the function to shift data are implemented as a result of the microprocessor 111 reading and executing the programs. The cache memory 113 stores write data received from the host 20 and data which are read from the logical disk device (sometimes called the ‘disk device’ hereinbelow) 122.

The front-end communication interface 114 is an interface for communicating with the host 20. The disk interface 115 is an interface for communicating with the respective disk devices 122 in the disk array system 120. The tape interface 116 is an interface for communicating with the respective tape devices 133 in the tape library system 130.

The disk array system 120 comprises a plurality of hard disk drives 121. A RAID group can be constituted by integrating the physical storage areas of each of the disk drives 121. The physical storage area of the RAID group can provide a logical disk device 122 of a fixed size or a variable size. Alternatively, one or a plurality of logical disk devices 122 can be established in the physical storage area of one hard disk drive 121. As described in FIG. 1, a hard disk is shown as an example of a random access-type storage device but the present invention is not limited to using hard disks. Another random access-type storage device such as flash memory device may also be used and hard disks and flash memory may also be mixed.

The tape library system 130 comprises, for example, a robot 131, a tape drive 132, and a plurality of tape devices 133. The robot 131 controls the movement of the tape devices 133. The robot 131 sets the tape devices 133 in the tape drive 132 and takes the tape device 133 from the tape drive 132 and archives same in a predetermined location. The tape drive 132 writes data to the tape device 133 and reads data from the tape device 133. The tape device 133 is a sequential access-type storage device that stores the data on a magnetic tape.

FIG. 3 schematically shows the content stored in the control memory 112. The control memory 112 stores, for example, disk control program 201, a tape library control program 202, virtual volume management table 203, a virtual volume page information table 204, a disk pool management table 205, a TG (Tape Group) pool management table 206, an inactivate program 207, and an activate program 208.

The relationship between the virtual volumes 310, and the disk pool 320 and a TG pool 330 will first be described with reference to FIG. 4. FIG. 4 shows two virtual volumes 310(1) and 310(2) but, in cases where no particular distinction is required, these volumes are referred to as the virtual volumes 310.

The disk pool 320 is an aggregate of disk devices 122 which is managed by the disk control program 201. The disk control program 201 manages the disk devices 122 in the pool by using the disk pool management table 205.

The TG pool 330 is an aggregate of tape devices 133 managed by the disk control program 201. The disk control program 201 manages the tape devices 133 in the pool by using the TG pool management table 206. The TG 134 is a tape set in which the required number of tape devices for a data copy from disk to tape are grouped.

The virtual volumes 310 comprise a plurality of pages 311. The pages 311 each have a plurality of address ranges. An unused segment among a plurality of segments that constitute a disk device 122 in the disk pool 320 is assigned to each of the page address ranges in response to access to the address ranges (write access, for example). The assigned segment corresponds with a plurality of physical storage areas that constitute the disk device 122.

For example, page 311a of virtual volume 310(1) corresponds to segment 123a of disk device 122. Page 311b corresponds to segment 123b of disk device 122 and page 311c corresponds to segment 123c. Page 311d is associated with a segment of the very first disk device but is associated with segment 135d of TG 134 by means of the inactivate processing. Likewise, pages 311e, 311f, and 311h of the virtual volume 310(2) are associated with segments 135f, 135e, and 135h of TG 134.

That is, in this embodiment, data on the disk device 122 are relocated in the tape device 133 if necessary. A segment on the tape device is managed as a range from a given block to a given block counting from the head of the tape, for example.

Thus, the real storage area assigned to the virtual volume 310 is either a segment of disk device 122 or a segment of tape device 133. Host 20 provides a virtual size equal to or more than the real size as the storage size of the virtual volume 310. The real size is the total size of the segments assigned to the virtual volume 310.

Let us now return to FIG. 3. As mentioned earlier, the disk control program 201 has a function that uses virtual volume management table 203, virtual volume page information table 204, a disk pool management table 205, and a TG pool management table 206 to provide the host (content management program 210, for example) with the virtual volume 310. In cases where the host 20 writes data to a blank page of the virtual volume 310, the disk control program 201 assigns a segment of a disk device 122 to this page. In addition, the disk control program 201 has a function for controlling the disk devices 122.

The tape library control program 202 is a program for controlling the tape library system 130. In cases where data are copied between a disk device 122 and tape device 133, inactivate program 207 and activate program 208 are executed. In processing of inactivate and processing of activate, the tape library control program 202 is employed in the writing of data to the tape device 133 and in the reading of data from the tape device 133. The inactivate program 207 and activate program 208 are executed by suitably calling the tape library control program 202 if necessary. When the inactivate processing and activate processing are described subsequently, a description relating to the calling of the tape library control program 202 is omitted in order to prevent redundancy in the description.

The inactivate program 207 works with the disk control program 201 and tape library control program 202 and has a function for copying the data of the disk device 122 in page 311 units to the tape device 133 (TG 134). In addition, the inactivate program 207 has a function that uses page management table 204 to judge the page 311 whose data are to be copied from the disk device 122 to the tape device 133 (whose data are to be relocated). For example, the inactivate program 207 is able to manage the last access time for each page and judge that a page 311 which has not been accessed for a fixed period is a page that is to be relocated in the tape device 133.

The activate program 208 works with the disk control program 201 and tape library control program 202 and possesses a function that copies data of the tape device 133 to the disk device 122 in TG 134 units or page 311 units.

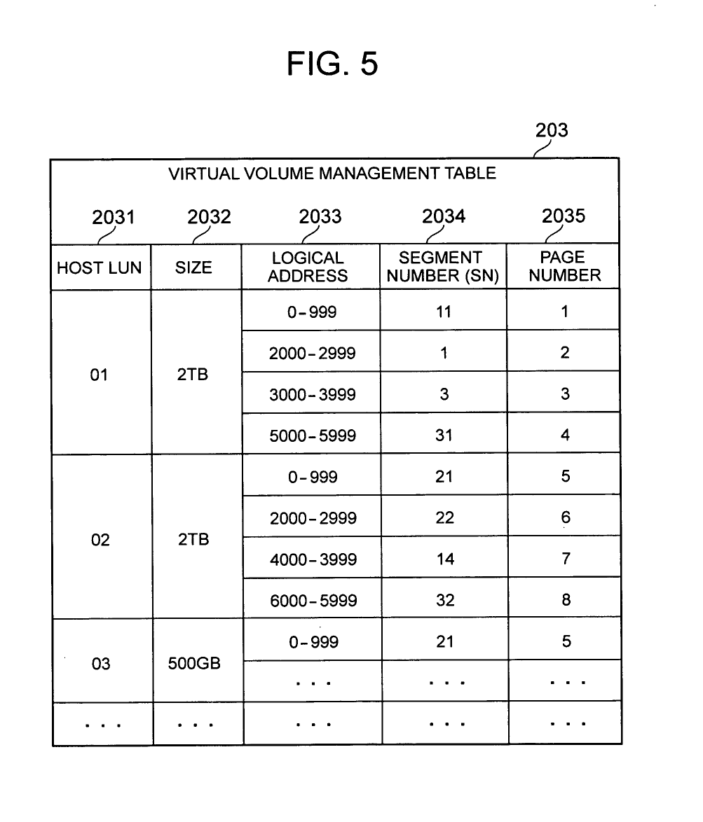

FIG. 5 shows a constitutional example of virtual volume management table 203.

The virtual volume management table 203 is a table that manages the respective segments assigned as real storage areas to the virtual volume 310. The virtual volume management table 203 records, for each virtual volume 310, a host LUN 2031, size 2032, a logical address 2033, a segment number 2034, and a page number 2035, for example.

The host LUN 2031 is a unique number also referred to as the ‘host logical unit number’ which discriminates each logical volume which the disk control program 201 provides for the host 20. In this embodiment, the virtual volume 310 is supplied to the host 20 as a logical volume.

The size 2032 is the storage capacity of the virtual volume 310. The logical address 2033 indicates the address range of the virtual volume 310 which is associated with a segment of the disk device 122 or a segment of the tape device 133. For example, the logical addresses ‘0 to 999’ represent the address range from logical block address (LBA) 0 to 999.

The segment number 2034 is a number that uniquely specifies the real storage area which is managed by the disk pool management table 205 and TG pool management table 206. Therefore, the segment number specifies a particular segment of a particular disk device 122 or a particular segment of a particular tape device 133. The segment number is sometimes shown as ‘SN’.

The page number 2035 is a number for uniquely discriminating the respective pages 311 of the virtual volume 310. As mentioned earlier, the respective pages 311 are defined as the range of the respective logical addresses.

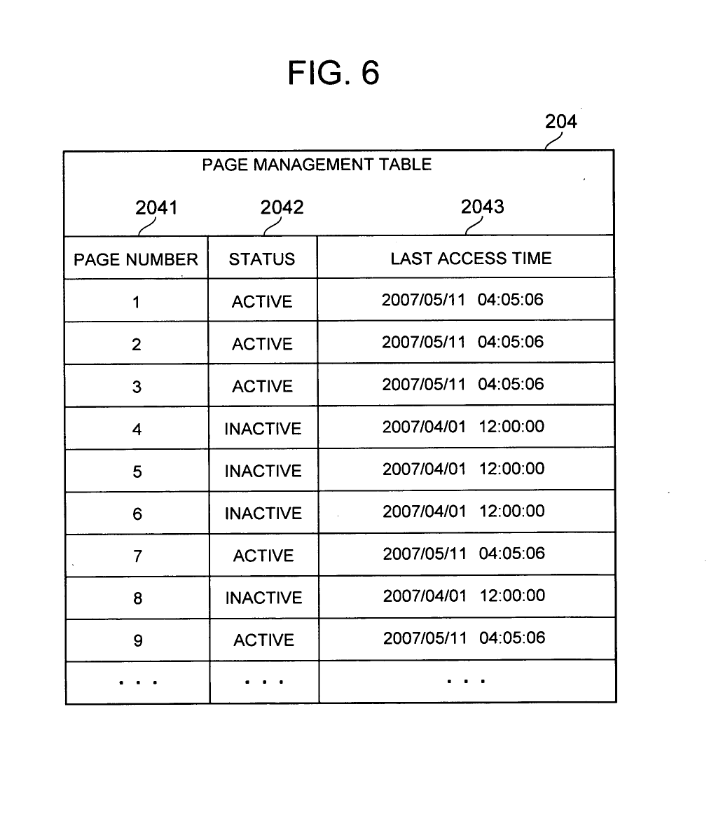

FIG. 6 shows a constitutional example of the page management table 204. The page management table 204 manages the states of the respective pages 311 of the virtual volume 310. The page management table 204 records a page number 2041, status 2042, and last access time 2043 for each page.

The page number 2041 is a number that uniquely specifies each page of the virtual volume 310. The status 2042 indicates the storage destination of the data of each page 311. That is, status 2042 makes the distinction for each page of whether a segment in a disk device 122 has been assigned or whether a segment in a tape device 133 has been assigned. The status of a page associated with a segment of the disk device 122 is ‘active’ and the status of a page associated with a segment of the tape device 133 is ‘inactive’.

In cases where a read command or write command is issued by the host 20 to a page 311 in an active state, the controller 110 responds normally. In contrast, in cases where a read command or write command is issued by the host 20 to a page 311 in an inactive state, the controller 110 responds with an error.

The last access time 2043 represents the time each page is last accessed by the host 20. However, the information is not limited to the last access time. As long as the information is information that allows the pages which are to be relocated from the disk device 122 to the tape device 133 to be judged, the inactivate program 207 is able to utilize information representing the access frequency of the host 20 with respect to each page 311 instead of the last access time or in conjunction with the last access time, for example. In addition, the time when a segment of the disk device 122 is assigned to the page 311 of the virtual volume 310 may also be recorded in table 204.

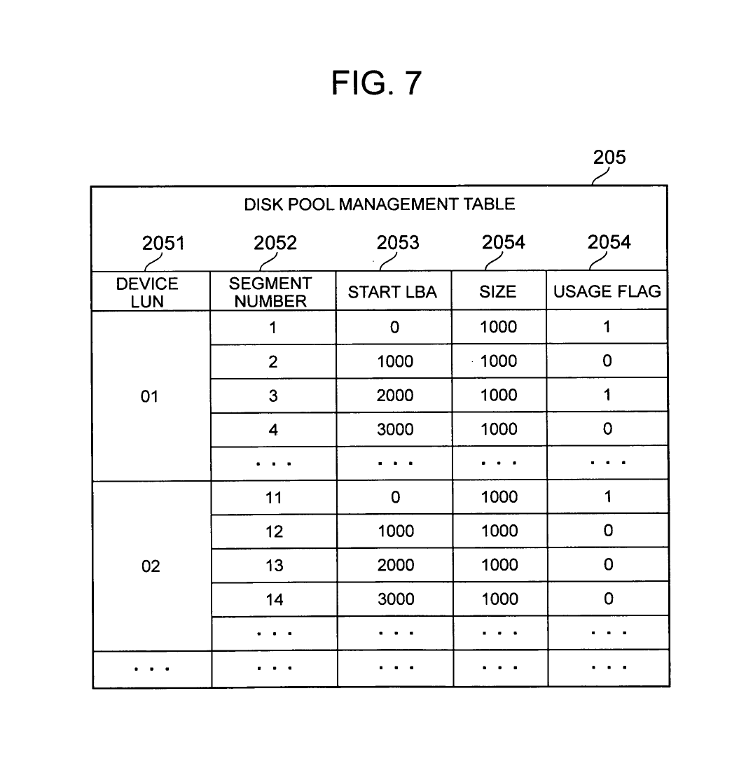

FIG. 7 shows a constitutional example of the disk pool management table 205. The disk pool management table 205 manages the real storage areas provided by the disk devices 122 as a disk pool 320. In cases where a real storage area is required by the virtual volume 310, a real storage area (segment) that can be assigned to the virtual volume 310 is selected from the disk pool 320 and the selected real storage area is assigned to the virtual volume 310.

The disk pool management table 205 records a device LUN 2051, segment number 2052, start LBA 2053, size 2054, and usage flag 2054.

The device LUN 2051 is the number which identifies the disk device 122. The device LUN is determined by the disk control program 201, for example. The device LUN 2051 and disk device 122 do not need to correspond one-to-one. A plurality of device LUN 610 may also be assigned to one disk device 122 or one device LUN 610 may be commonly assigned to a plurality of disk devices 122.

A segment is the minimum unit for dividing and managing the storage areas of the disk devices 122 and tape devices 133. Segments are managed by the disk control program 201. Segment number 2052 is a unique identification number with which the disk control program 201 manages the segments.

The start LBA 2053 represents the physical position in which a segment starts in a disk device 122 specified by the device LUN 2051. That is, the start LBA 2053 represents the start of the storage area of the disk device 122. The size 2054 represents the size of the segment. The size 2054 expresses the size of the segment as the number of logical blocks starting from the start LBA 2053.

The usage flag 2054 indicates the state of usage of the segment. The usage flag 2054 indicates, using two values, whether the segment is being used by the disk control program 201. When the segment is being used, ‘1’ is set, and, when the segment is not being used, ‘0’ is set.

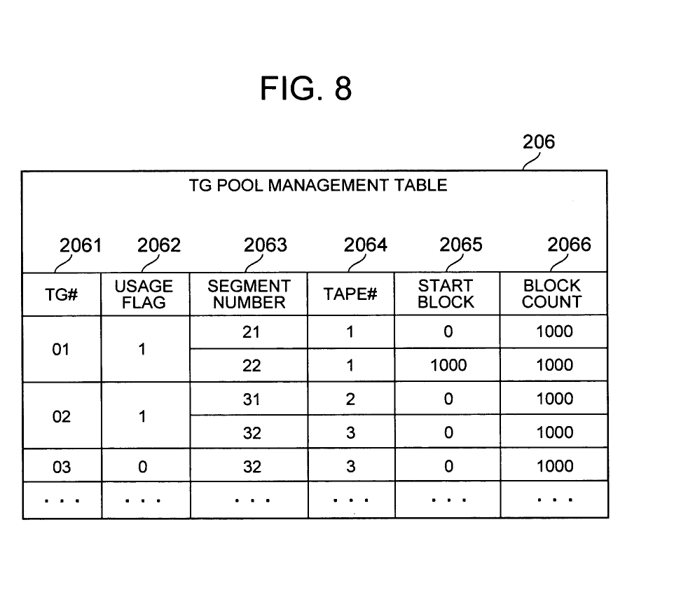

FIG. 8 shows a constitutional example of the TG pool management table 206. The TG pool management table 206 manages the real storage areas which are provided by the tape device 133 as TG pool 330.

In cases where the relocation of data from the disk device 122 to the tape device 133 is required for the virtual volume 310, a TG 134 which can be assigned to the virtual volume 310 is selected from the TG pool 330 and the selected TG 134 is assigned to the virtual volume 310.

The TG pool management table 206 records a TG number (TG#) 2061, a usage flag 2062, a segment number 2063, a tape number 2064, a start block 2065, and a block count 2066.

The tape device 133 is a sequential access-type device and, therefore, unlike the disk pool management table 205, the segments of the respective tape devices 133 are managed on the basis of the results of the data copy from the disk device 122 to the tape device 133 by the inactivate program 207.

The TG number 2061 is a number that uniquely identifies the TG 134. The usage flag 2062 is information that makes the distinction of whether the TG 134 is being used by the disk control program 201. In cases where the TG 134 is being used, ‘1’ is set and, in cases where the TG 134 is not being used, ‘0’ is set.

The segment number 2063 is a number that identifies a segment of the TG 134. The tape number 2064 is a number that specifies the tape device 133 in which the segment is stored. The start block 2065 indicates the segment monitoring position. The block count 2066 indicates the size of the segment.

In cases of an unused TG 134, ‘0’ is set for the usage flag and a tape device 133 is not assigned. The relationship between the TG 134 and tape device 133 is determined at the time of a data copy from the disk device 122 to the tape device 133 which is performed by the inactivate program 207. In cases where data are shifted from the disk device 122 to the tape device 133, the tape device 133 is assigned from the tape pool to the TG 134 and the assigned result is recorded in the TG pool management table 206. Although not especially illustrated, a tape pool is an aggregate of tape devices 133 which can be used in a data copy from the disk device 122 to the tape device 133.

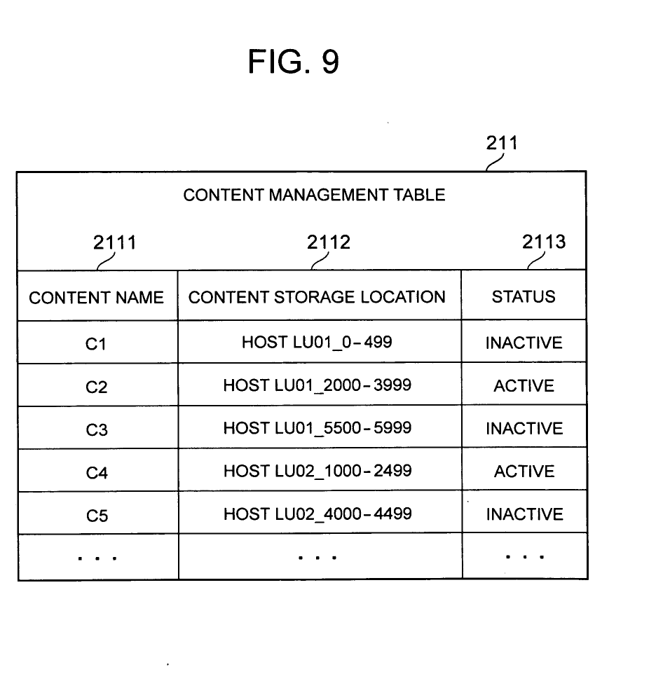

FIG. 9 shows a constitutional example of the content management table 211. The content management table 211 is used by the content management program 210 to manage the content data. The content data are sometimes called content. Content is a unit of data handled by the user in the host 20. Content may be a file or may be data in a database.

The content management table 211 records a content name 2111, a content storage location 2112, and status 2113. The content name 2111 may be a name that allows the content management program 210 to uniquely identify the content. The storage location 2112 indicates the storage location of the content in the virtual volume 310. The content storage location is indicated by information such as an address range where the content is stored from a particular address to a particular address of the virtual volume which is specified by the host LUN.

The status 2113 indicates the actual storage location of each content item. In cases where the actual storage location of the content is the disk device 122, ‘active’ is set for the status 2113. In cases where the actual storage location of the content is a tape device 133, ‘inactive’ is set for the status 2113.

In this embodiment, the content storage locations 2112 are managed by the content management table 211 and the host 20 and virtual disk library system 10 communicate and convert information relating to the content storage location 2112. Therefore, the content management program 210 is able to ascertain on which page 311 of the virtual volume 310 each content item is stored.

In cases where the statuses 2042 of all the pages 311 where content is stored are active, the content status 2113 is set to active. In cases where even one page 311 in an inactive state exists, inactive is set for the status 2113 of this content.

When the host 20 issues a write command or read command to a page in an inactive state, the controller 110 responds to the host 20 with an error. However, the action is not limited to an error response. The constitution may also be such that access to inactive-state content is prohibited by the content management program 210.

The constitution may also be such that the status 2113 is updated as a result of the host 20 and virtual disk library system 10 communicating after the processing by the inactivate program 207 or activate program 208 is complete. The constitution may also instead be such that the status 2113 is updated as a result of the host 20 and virtual disk library system communicating at regular intervals.

The status 2113 of the content is used to allow the user to see whether each content item has been stored by the content management program 210 in a disk device 122 or in a tape device 133. Further, when content is stored in the virtual disk library system 10, for example, the content and page can also be stored in one-to-one correspondence. In this case, an archive can also be made from the disk device 122 to the tape device 133 in content units.

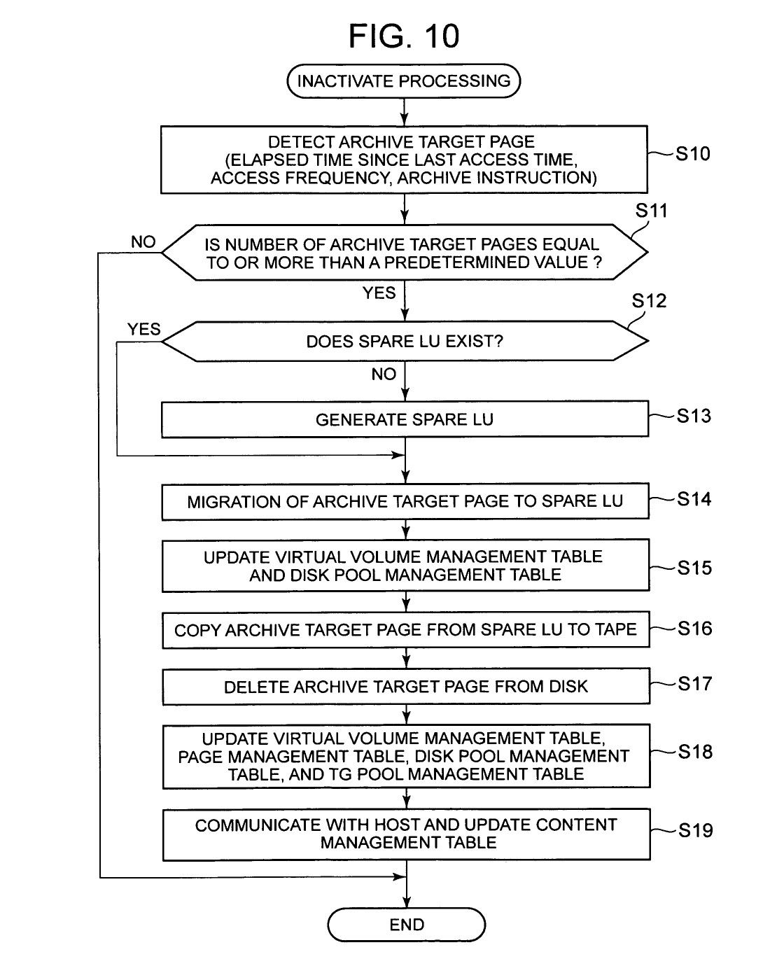

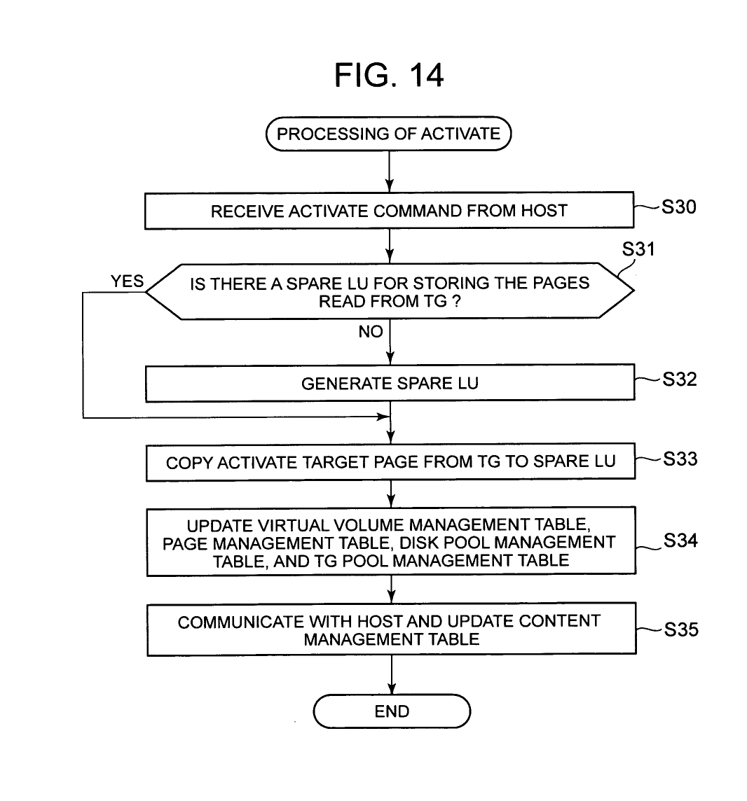

FIG. 10 is a flowchart showing the processing of inactivate. The inactivate processing is executed by the inactivate program 207. The flowchart of FIG. 14 provides an overview of each processing to the extent that is required in order to understand and carry out the present invention and sometimes differs from the actual computer program. A so-called person skilled in the art will surely be able to change the illustrated steps, the switch the order of the steps and add new steps which are non-essential. The controller 110 is described as the subject hereinbelow.

The controller 110 uses the page management table 204 to detect archive target pages (S10). Archive target pages are pages which are to be shifted from a disk device 122 to a tape device 133. For example, pages which, on the basis of the last access time, have not been accessed for a fixed period among the pages set to the active state are detected as archive target pages.

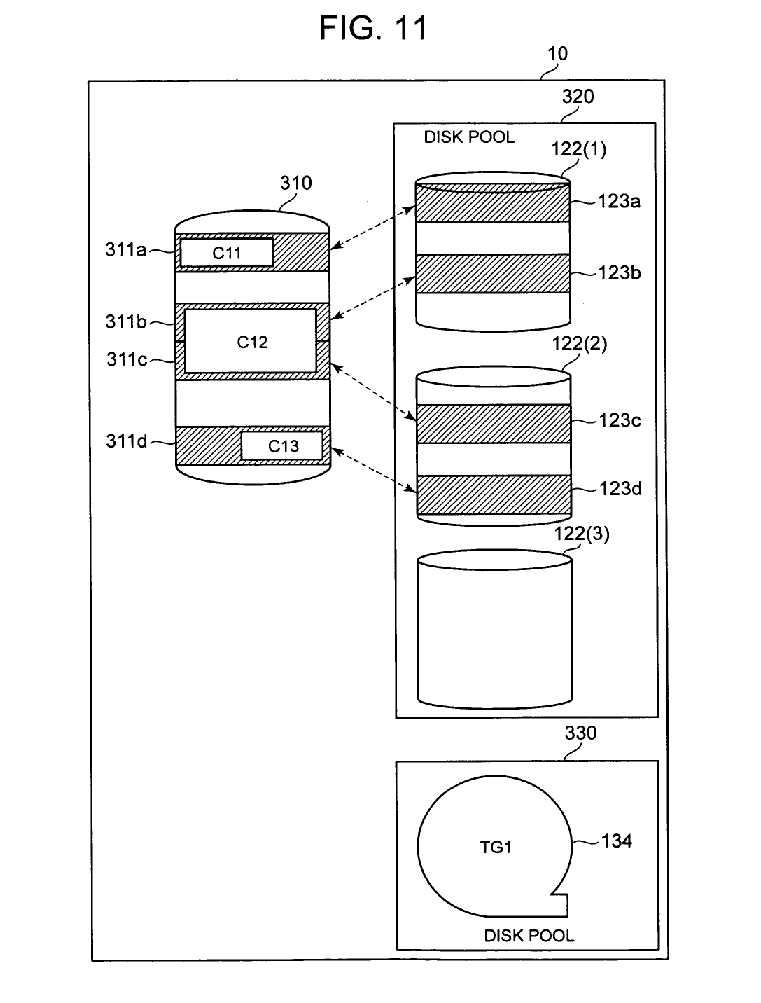

FIGS. 11 to 13 are explanatory diagrams that schematically show the flow of inactivate processing. The content C11 is stored on page 311a of the virtual volume 310; content C12 is stored on pages 311b and 311c and content C13 is stored on page 311d.

Page 311a is associated with segment 123a of disk device 122(1); page 311b is associated with segment 123b of disk device 122(1); page 311c is associated with segment 123c of disk device 122(2); page 311d is associated with segment 123d of disk device 122(2). In FIG. 11, a predetermined time since the last access time has elapsed for pages 311a and 311d and same are therefore detected as archive target pages.

Let us now return to FIG. 10. The controller 110 judges whether there exists a number of archive target pages that is equal to or more than a predetermined value that is set beforehand (S11). This is because collecting data of a predetermined value or more and shifting these data to a tape device 133 is efficient. This processing ends in cases where the number of archive target pages is less than the predetermined value (S11: NO).

In cases where the number of archive target pages is equal to or more than a predetermined value (S11: YES), the controller 110 judges whether a spare disk device 122 for shifting the archive target pages to the tape device 133 exists in the disk pool 320 (S12).

The spare disk device 122 used for the data migration is a disk device in which all the segments in the disk device 122 have not been assigned to the virtual volume 310 and is of a larger size than the total size of the archive target pages. For example, in the example shown in FIG. 11, the disk device 122(3) is detected as a data migration spare disk device.

In cases where a spare disk device 122(3) for data migration is detected (S12: YES), the processing moves to S14 (described subsequently). In cases where a spare disk device for data migration has not been detected (S12: NO), the controller 110 generates a spare disk device for usage in the data migration (S13). The constitution may also be such that a spare disk device for data migration is prepared before starting the inactivate processing. The spare disk device for data migration may also be constituted by a plurality of disk devices 122.

One example where a spare disk device for data migration is generated will now be described. A spare disk device for data migration can be generated by shifting the data stored in a certain disk device to another disk device.

For example, in FIG. 11, a case is considered where only disk device 122(1) and disk device 122(2) exist in disk pool 320 and disk device 122(3) does not exist.

In this case, the data of segment 123c and segment 123d of disk device 122(2) are copied to spare segments of disk device 122(1). The assignment destination segments of pages 311c and 311d are then changed to the segments of the disk device 122(1). That is, the disk device 122(2) can be rendered a spare disk device by shifting the data stored in the disk device 122(2) to the disk device 122(1) (S13).

However, in S14, which will be described subsequently, the archive target pages are shifted from the disk device 122(1) to the disk device 122(2). Hence, of the data stored in the disk device 122(2), the data of the archive target pages may remain in the disk device 122(2) instead of being shifted to the disk device 122(1).

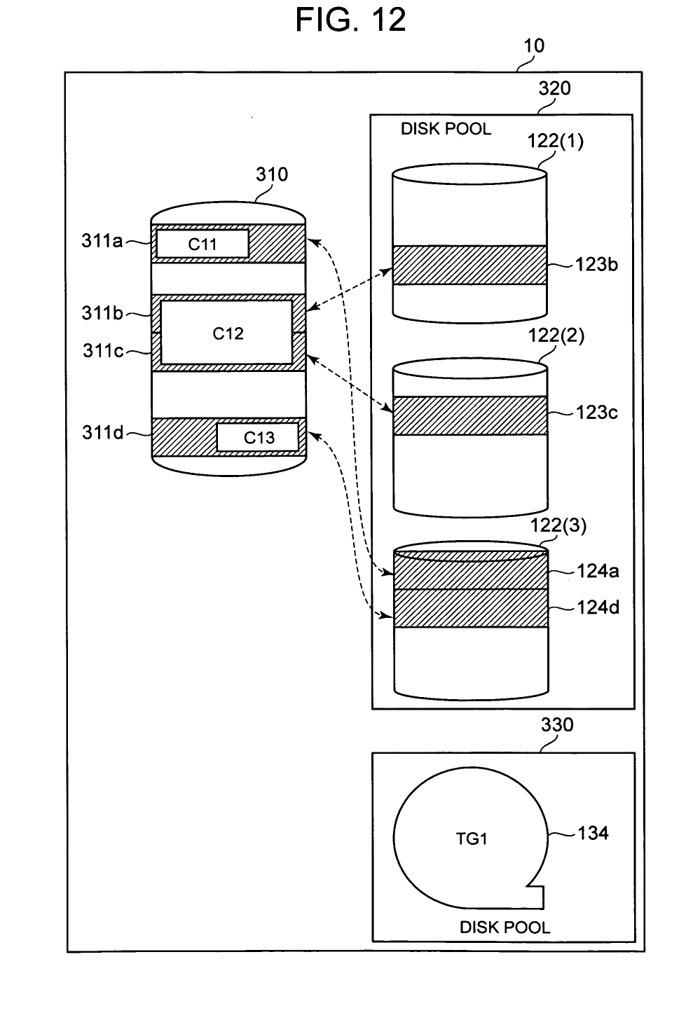

Let us now return to FIG. 10. The controller 110 transfers the data of the archive target pages to a spare disk device (S14). This aspect is shown in FIG. 12. The segments 124a and 124d of data migration disk device 122(3) each store the data of archive target pages.

The controller 110 updates the virtual volume management table 203 and disk pool management table 205 (S15). When this is illustrated using the example shown in FIG. 12, in the virtual volume management table 203, the assignment destination segment of page 311a is changed from segment 123a in disk device 122(1) to segment 124a in disk device 122(3). Likewise, the assignment destination segment of page 311d is changed from segment 123d in disk device 122(2) to segment 124d in disk device 122(3).

In the disk pool management table 205, a usage flag is set to ‘0’ for segment 123a of disk device 122(1) and segment 123d of disk device 122(2) whose associations with a page have been cancelled. Segments 123a and 123d whose usage flags have been set to ‘0’ can be assigned to other pages in the virtual volume 310. That is, segments whose usage flag have been set to ‘0’ can be re-used.

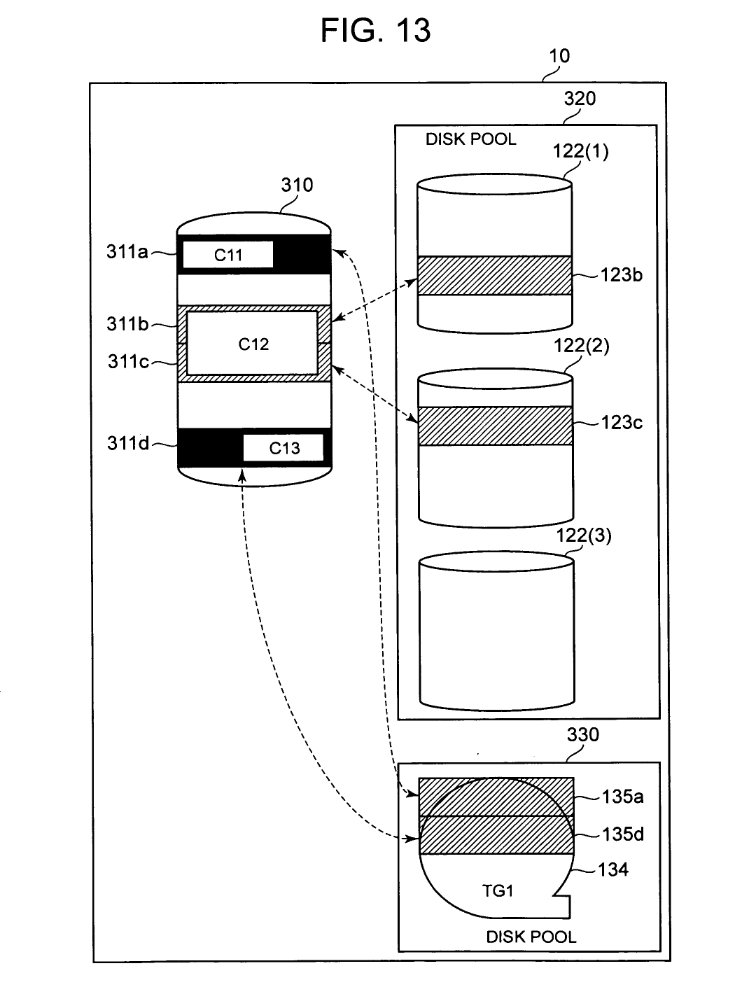

As shown in FIG. 13, the controller 110 copies the data of the archive target pages from disk device 122(3) to the tape device (S16). The data stored in the disk device 122(3) are copied to TG 134.

Here, only the data of the archive target pages are stored in the disk device 122(3) which is the copy source. The copy-source disk device 122(3) is originally generated as a spare disk device and stores only the archive target data which have not been accessed by the host 20.

Therefore, during the data migration from the copy source disk device 122(3) to the TG 134, the probability of the host 20 accessing the copy source disk device 122(3) is considered to be small. As a result, the copy speed can be kept constant by preventing fluctuations in the load during the data migration and the reliability of the data migration to the tape device can be increased. Further, a constitution is possible where, in cases where access by the host 20 to the copy source disk device 122(3) is not completely excluded during data migration, access by the host 20 to the archive target pages during processing of inactivate may be prohibited.

In S17, the controller 110 deletes the data of the archive target pages from the disk device.

The controller 110 updates each of the virtual volume management table 203, the page management table 204, the disk pool management table 205, and the TG pool management table 206 (S18).

In the virtual volume management table 203, the segment numbers 2034 of the archive target pages are updated from the segments in the disk device 122 to the segments in the tape device 133. In the page management table 204, the statuses 2042 of the archive target pages are updated to inactive. In the disk pool management table 205, the usage flags 2054 of the respective segments of the disk devices to which the archive target pages have been assigned are set to ‘0’. Since the usage flags are changed to 0, these segments can be assigned to other pages and are reusable. The TG pool management table 206 records which position in the tape device 133 the data copied to the TG 134 are copied to.

The controller 110 communicates with the host 20 and updates the content management table 211 (S19). The content management program 210 updates the status 2113 of the content 2111 stored in the archive target page to inactive, for example.

As indicated by the black square in FIG. 13, those pages among the respective pages of the virtual volume 310 which have been archived in the tape device are associated with segments of the tape device and enter an inactive state. The host 20 is unable to access pages in an inactive state. In cases where the host 20 desires access to pages in an inactive state, processing of activate is required.

FIG. 14 is a flowchart showing processing of activate. Processing of activate may be carried out in TG units or performed in page units. Here, a case where processing of activate is performed in TG units will mainly be described.

The host 20 designates the content for which activation is required and issues an activate command to the virtual disk library system 10. Upon receipt of an activate command (S30), the controller 110 judges whether a spare disk device for storing data which are read from the TG 134 exists (S31). That is, data are read from the TG 134 which has the segment which corresponds with the page where the designated content is stored and judges whether there is a spare disk device for storage.

In cases where a spare disk device exists (S31: YES), the processing moves to S33 (described subsequently). In cases where a spare disk device does not exist (S31: NO), the controller 110 is able to create a spare disk device of the required size by implementing the migration of data which are stored in a certain disk device segment to another segment, as per FIG. 10 (S32).

Further, in cases where processing of activate is carried out in page units, a size that allows the page where the designated content is stored to be copied is sufficient. That is, a segment of the size required to store the data of the page may be secured.

The controller 110 transfers and copies the data stored in the data migration source TG 134 to the migration destination spare disk device (S33). The migration source TG is the TG that comprises the segment which corresponds with the page where the designated content is stored.

The controller 110 updates the virtual volume management table 203, page management table 204, disk pool management table 205, and TG pool management table 206 (S34).

In the virtual volume management table 203, the segment number 2034 of the page which corresponds with the designated content is updated from a segment in the tape device 133 to a segment in the disk device 122. In the page management table 204, the status 2042 of the page which corresponds with the designated content is updated to active. In the disk pool management table 205, the usage flags 2054 of the respective segments of the disk devices to which data are shifted from the data migration source TG is changed to ‘1’. In cases where the data stored in the migration source TG are deleted from the TG pool management table 206, the usage flag 2062 is changed from ‘1’ to ‘0’. In cases where the content is shifted to the disk device 122 only temporarily, there is no need to delete the data stored in the tape device.

The controller 110 communicates with the host 20 and updates the content management table 211 (S35). The content management program 210 updates the status 2113 of the content stored in the migration source TG, for example, in the content management table 211 to active, for example.

This embodiment exhibits the following effects on account of the above constitution. In this embodiment, a virtual volume is constituted by a smaller number of pages than the volume size and the data can be shifted from a disk device to a tape device in page units. Hence, the granularity of the data migration drops and data which does not need to be held in the disk device can be efficiently switched from the disk device to the tape device to permit a reduction in the data archiving costs.

In this embodiment, data are copied from the disk device to the tape device by using a spare disk device with a small probability of being accessed by the host. Hence, the data copy speed can be kept constant and the reliability of the data stored in the tape device can be increased.

In this embodiment, the physical position of a page of the virtual volume can be made to correspond with either a disk device or tape device and a page which is associated with a tape device is set to the inactive state. Hence, the actual storage destination can be changed without changing the position of the data in the virtual volume.

In this embodiment, the data storage destination is changed between the disk device and tape device within the virtual disk library system. Hence, data migration is possible without affecting the host.

### Second Embodiment

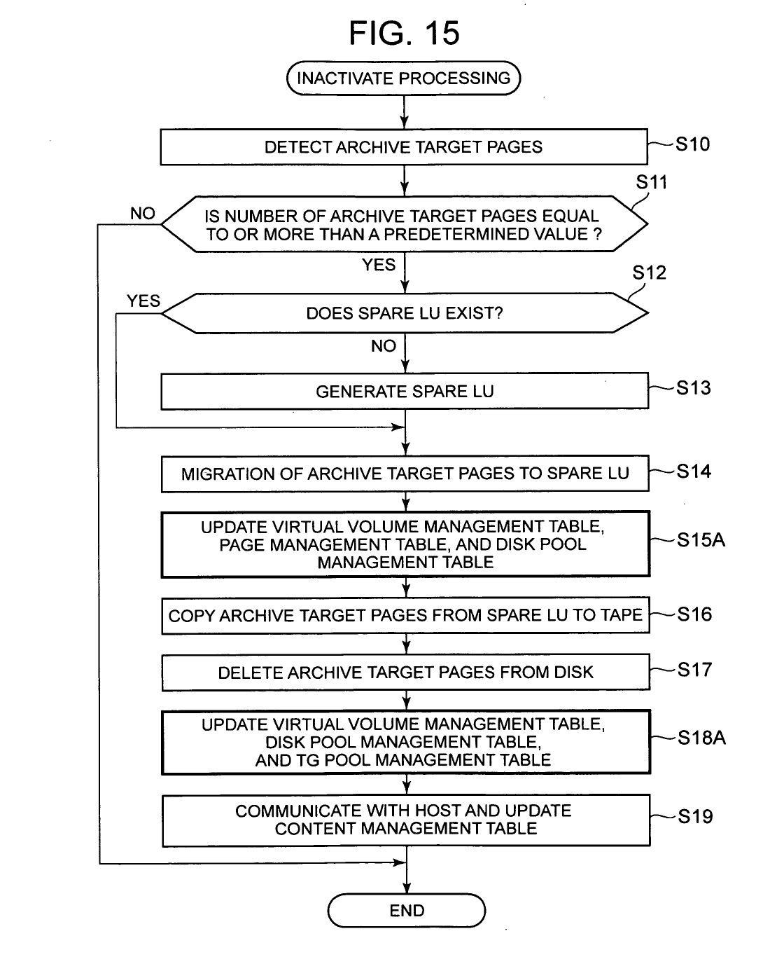

A second embodiment will now be described on the basis of FIG. 15. The following embodiments which include this embodiment each correspond to modified examples of the first embodiment. A description that overlaps that for the first embodiment is omitted here. In this embodiment, after the data of the archive target pages have been collected in a spare disk device (S14), the status 2042 of the page management table 204 is changed to inactive (S15A). Hence, in S18A, the page management table 204 is not updated. As a result, before the data migration from the disk device to the tape device is started, access by the host to the archive target page can be prohibited. This embodiment which is thus constituted also affords the same effects as those of the first embodiment.

### Third Embodiment

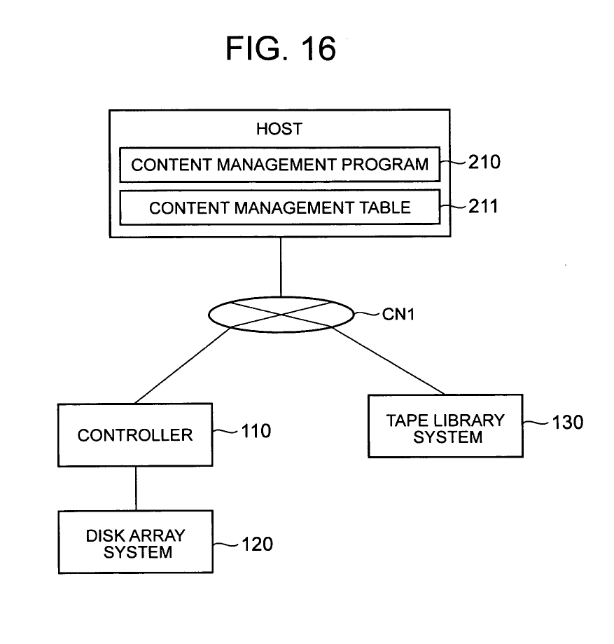

A third embodiment will now be described on the basis of FIG. 16. In this embodiment, the controller 110, disk array system 120, and tape library system 130 are constituted as separate enclosures and mutually connected by communication network CN1. This embodiment which is thus constituted also affords the same effects as those of the first embodiment.

The present invention is not limited to the embodiments hereinabove. A person skilled in the art is able to make a variety of additions and modifications within the scope of the present invention.

What is claimed is:

1. A storage control apparatus that is used by a host computer, comprising:
a virtual volume which is constituted by a plurality of virtual storage areas of a predetermined size which are each associated with a real storage area;
a data migration control section that detects a migration target virtual storage area among the respective virtual storage areas and either shifts data stored in the detected migration target virtual storage area from the real storage area of a random access-type storage device to the real storage area of a sequential access-type storage device or shifts the data stored in the detected migration target virtual storage area from the real storage area of the sequential access-type storage device to the real storage area of the random access-type storage device; and
a virtual volume control section which generates the virtual volume and supplies the virtual volume to the host computer, and which associates the virtual storage area with either the real storage area of the random access-type storage device or the real storage area of the sequential access-type storage device on the basis of the result of the data migration by the data migration control section.

2. The storage control apparatus according to claim 1, where in the data migration control section uses a spare storage area in which data that is likely to be accessed by the host computer are not stored, to shift data between the random access-type storage device and the sequential access-type storage device.

3. The storage control apparatus according to claim 1, wherein the data migration control section is configured such that (1) in cases where an archive target virtual storage area among the respective virtual storage areas which matches a preset archive policy is detected, the data migration control section shifts data which are stored in the real storage area of the random access-type storage device which is associated with the archive target virtual storage area to the real storage area of the sequential access-type storage device, and (2) in cases where a recovery instruction is issued for the virtual storage area among the respective virtual storage areas which is associated with the real storage area of the sequential access-type storage device, the data migration control section shifts data which are stored in the real storage area of the sequential access-type storage device to the real storage area of the random access-type storage device.

4. The storage control apparatus according to claim 3, wherein the archive policy is either a case where the elapsed time since the last time access is performed by the host computer exceeds a predetermined time that is preset, or a case where the frequency of access by the host computer is less than a predetermined value that is preset, or a case where an archive instruction is issued by the host computer.

5. The storage control apparatus according to claim 1, wherein the virtual volume control section reports an error to the host computer in cases where the host computer accesses the virtual storage area associated with the real storage area of the sequential access-type storage device among the respective virtual storage areas.

6. The storage control apparatus according to claim 1, further comprising:
a data management section that manages the correspondence relationship between the content data utilized by the host computer and the respective virtual storage areas, and manages whether the content data are stored in either the real storage area of the random access-type storage device or the real storage area of the sequential access-type storage device,
wherein, as a result of the data management section issuing an archive instruction or recovery instruction to the data migration control section, the data migration control section shifts the data stored in the migration target virtual storage area from the real storage area of the random access-type storage device to the real storage area of the sequential access-type storage device, or shifts the data stored in the migration target virtual storage area from the real storage area of the sequential access-type storage device to the real storage area of the random access-type storage device.

7. The storage control apparatus according to claim 1, wherein the random access-type storage device is either a hard disk device or a flash memory device, and the sequential access-type storage device is a magnetic tape device.

8. A data archiving method for a storage control apparatus, comprising the steps of:
generating a virtual volume from a plurality of virtual storage areas of a predetermined size which can be associated with either a real storage area of a random access-type storage device or a real storage area of a sequential access-type storage device;
detecting an archive target virtual storage area among the respective virtual storage areas;
shifting data stored in the real storage area of the random access-type storage device which corresponds with the detected archive target virtual storage area to the real storage area of the sequential access-type storage device by using a spare storage area;
associating the archive target virtual storage area with the real storage area of the migration destination sequential access-type storage device; and
responding to access to the archive target virtual storage area with an error.

9. The data archiving method for a storage control apparatus according to claim 8, further comprising a step of:
shifting data that have been shifted to the real storage area of the migration destination sequential access-type storage device, to the real storage area of the random access-type storage device in cases where a recovery instruction has been issued.

10. A storage system having a host computer and a library system that is utilized by the host computer,
wherein (1) the library system comprises a first storage section that has a plurality of random access-type storage devices, a second storage section that has a plurality of sequential access-type storage devices, and a controller for controlling the first storage section and the second storage section;
(2) the controller comprises:
(2-1) a virtual volume which is constituted by a plurality of virtual storage areas of a predetermined size, each of the virtual storage areas being associated with a real storage area;
(2-2) a data migration control section that detects a migration target virtual storage area among the respective virtual storage areas, and (2-2-1) shifts data stored in the detected migration target virtual storage area from the real storage area of the random access-type storage device to the real storage area of the sequential access-type storage device or (2-2-2) shifts the data stored in the detected migration target virtual storage area from the real storage area of the sequential access-type storage device to the real storage area of the random access-type storage device; and
(2-3) a virtual volume control section which generates the virtual volume and supplies the virtual volume to the host computer, and which associates the virtual storage area with either the real storage area of the random access-type storage device or the real storage area of the sequential access-type storage device on the basis of the result of the data migration by the data migration control section;
(3) the host computer comprises a data management section that manages the correspondence relationship between the content data and the respective virtual storage areas, and manages whether the content data are stored in either the real storage area of the random access-type storage device or the real storage area of the sequential access-type storage device; and
(4) the data migration control section shifts data between the random access-type storage device and the sequential access-type storage device on the basis of an archive instruction or recovery instruction issued by the data management section.
